(19) United States
(12) Patent Application Publication
(10) Pub. No.: US 2020/0120199 A1
(43) Pub. Date: Apr. 16, 2020

(54) METHOD OF PROVIDING NOTIFICATION ACCORDING TO SURROUNDING SITUATION OF INTELLIGENT TERMINAL AND DEVICE FOR THE SAME

(71) Applicant: LG ELECTRONICS INC., Seoul (KR)

(72) Inventors: Jichan MAENG, Seoul (KR); Wonho SHIN, Seoul (KR); Taehyun KIM, Seoul (KR)

(73) Assignee: LG ELECTRONICS INC., Seoul (KR)

(21) Appl. No.: 16/711,045

(22) Filed: Dec. 11, 2019

(30) Foreign Application Priority Data
Aug. 6, 2019 (KR) 10-2019-0095713

(51) Int. Cl. H04M 1/725; H04L 12/58; G08B 6/00; G06N 3/08; G06N 3/04

(52) U.S. Cl. CPC H04M 1/72569; H04L 51/32; H04L 51/24; G06Q 20/3223; G06N 3/08; G06N 3/04; G08B 6/00

(57) ABSTRACT

Provided are a method of providing a notification and a device for the same. The method of providing the notification has an effect in that a terminal detects a surrounding situation and recognizes the surrounding situation, thereby providing a notification according to a preset notification setting based on the recognized surrounding situation. The terminal can be connected to an artificial intelligence module, a drone (unmanned aerial vehicle (UAV)), a robot, an augmented reality (AR) device, a virtual reality (VR) device, a device related to a 5G service, and the like.

### CROSS-REFERENCE TO RELATED APPLICATIONS

This application claims the priority benefit of Korean Patent Application No. 10-2019-0095713 filed on Aug. 6, 2019, which is incorporated herein by reference for all purposes as if fully set forth herein.

### BACKGROUND OF THE INVENTION

### Field of the Invention

The present disclosure relates to a method of providing a notification, and more particularly, to a method of providing a notification appropriate to a surrounding situation based on a surrounding situation and a device for the same.

### Related Art

Recently, due to development of information and communication technology, not only diversification of smartphones but also functions thereof have been much improved. Further, more than one smartphone per person is being distributed.

With the spread of such smartphones, in a specific situation, there is a need for appropriately adjusting notifications, i.e., volume, screen brightness, vibration, etc. of the smartphone.

However, it is very cumbersome for a user to change a notification every time in a specific situation, and a case occurs in which the user does not change the notification due to the user's error.

Therefore, various methods have been studied in which a smartphone recognizes a specific situation and provides a notification appropriate to a surrounding situation.

### SUMMARY OF THE INVENTION

An object of the present disclosure is to solve the above-described needs and/or problems.

The present disclosure provides a method of providing a notification appropriate to a surrounding situation based on a surrounding situation and a device for the same that can recognize a surrounding situation through various sensors installed in a smartphone and grasp the surrounding situation.

The present disclosure further provides a method of providing a notification appropriate to a surrounding situation based on a surrounding situation and a device for the same that recognize a surrounding situation by the smartphone and provide a notification appropriate to the surrounding situation.

In an aspect, a method of providing a notification of an intelligent terminal includes obtaining first information based on at least one of schedule information stored in the terminal, social network service (SNS) post information linked to a user account, and purchase history information of the user; obtaining second information through a plurality of sensors; recognizing a surrounding situation based on the first information and the second information; and providing a notification according to a preset notification setting based on the recognized surrounding situation, wherein the first information includes at least one of information about a specific time and information about a specific position, and wherein the second information includes at least one of position information, sound information, image information, and external signal information.

The preset notification setting can include at least one of a sound notification related setting, a screen brightness related setting, a vibration notification related setting, and a screen operation related setting.

The method can further include storing the recognized surrounding situation information.

The preset notification setting can be determined by deep neural network (DNN) learning of the stored recognized surrounding situation information.

The vibration notification related setting can be applied to a wearable device.

The screen operation related setting can be a setting related to an Always ON Display (AOD) or a high contrast screen.

When the second information includes the sound information or the image information, the method can further include extracting valid information through DNN learning of the sound information or the image information, wherein the recognized surrounding situation can be determined based on the valid information.

In another aspect, an intelligent terminal for performing a method of providing a notification includes a sensor unit including a plurality of sensors for obtaining second information; and a processor functionally connected to the sensor unit, wherein the processor is configured to obtain first information based on at least one of schedule information stored in the terminal, social network service (SNS) post information linked to a user account, and purchase history information of the user, to recognize a surrounding situation based on the first information and the second information, and to provide a notification according to a preset notification setting based on the recognized surrounding situation, wherein the first information includes at least one of information about a specific time and information about a specific position, and wherein the second information includes at least one of position information, sound information, image information, and external signal information.

The preset notification setting can include at least one of a sound notification related setting, a screen brightness related setting, a vibration notification related setting, and a screen operation related setting.

The intelligent terminal can further include a storage unit for storing the recognized surrounding situation information.

The preset notification setting can be determined by deep neural network (DNN) learning of the stored recognized surrounding situation information.

The screen operation related setting can be a setting related to an always on display (AOD) or a high contrast screen.

When the second information includes the sound information or the image information, the processor can be configured to extract valid information through DNN learning of the sound information or the image information, and wherein the recognized surrounding situation can be determined based on the valid information.

In another aspect, an electronic device includes at least one processor; a memory; and at least one program, wherein the at least one program is stored in a memory and is configured to be executed by the at least one processor, and the at least one program includes instructions for performing the method of claim 1.

### BRIEF DESCRIPTION OF THE DRAWINGS

The accompany drawings, which are included to provide a further understanding of the present disclosure and are incorporated on and constitute a part of the present specification illustrate embodiments of the present disclosure and together with the description serve to explain the principles of the present disclosure.

FIG. 1 is a conceptual diagram illustrating an embodiment of an artificial intelligence (AI) device.

FIG. 2 is a block diagram illustrating a wireless communication system that can be applied to methods proposed in the present specification.

FIG. 3 is a diagram illustrating an example of a signal transmitting/receiving method in a wireless communication system.

FIG. 4 illustrates an example of a basic operation of a user terminal and a 5G network in a 5G communication system.

FIG. 5 is a block diagram illustrating a terminal according to an embodiment of the present disclosure.

FIG. 6 illustrates an example of an operation of a user terminal using 5G communication.

FIG. 7 is a block diagram illustrating an AI device according to an embodiment of the present disclosure.

FIG. 8 illustrates an example of an operation in which a notification providing method proposed in the present specification is executed.

FIG. 9 illustrates an example of an operation in which a notification providing method proposed in the present specification is executed using information detected through a sensor unit.

FIG. 10 illustrates a feedback method of a notification providing method proposed in the present specification.

FIG. 11 is a diagram illustrating a deep neural network structure for a notification providing method proposed in the present specification.

FIG. 12 is a flowchart illustrating an execution example of a notification providing method proposed in the present specification.

FIG. 13 is a block diagram illustrating a terminal configuration in which a notification providing method proposed in the present specification is executed.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., can be used to describe various components, such components must not be limited by the above terms. The above terms are used only to distinguish one component from another.

When an element is “coupled” or “connected” to another element, it should be understood that a third element can be present between the two elements although the element can be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through sections A through G. Further, communication generation(s) above/below 5G communication may be used alone or in conjunction with 5G communication if applicable. Moreover, even though it may not be expressly mentioned, one or more components/features of any one of the device(s), system(s) and method(s) described herein can be applied to another one of the device(s), system(s) and method(s) described herein. In addition, all components of the devices, systems and methods described herein are operatively coupled and configured.

Three major requirement areas of 5G include (1) an enhanced mobile broadband (eMBB) area, (2) a massive machine type communication (mMTC) area, and (3) ultra-reliable and low latency communications (URLLC) area.

Some use cases can require multiple areas for optimization, and other use cases can be focused to only one key performance indicator (KPI). 5G supports these various use cases in a flexible and reliable manner.

The EMBB enables far beyond basic mobile Internet access and covers media and entertainment applications in rich interactive work, cloud or augmented reality. Data is one of key dynamic power of 5G, and in a 5G era, a dedicated voice service may not be seen for the first time. In 5G, a voice is expected to be treated as an application program using data connection simply provided by a communication system. Main reasons for an increased traffic volume are increase in content size and increase in the number of applications requiring a high data transmission rate. Streaming services (audio and video), interactive video, and mobile Internet connections will be used more widely as more devices connect to Internet. These many application programs require always-on connectivity in order to push real-time information and notifications to a user. Cloud storage and applications are growing rapidly in mobile communication platforms, which can be applied to both work and entertainment. Cloud storage is a special use case that drives growth of uplink data transmission rates. 5G is also used for remote tasks in cloud and requires much lower end-to-end delays so as to maintain excellent user experience when tactile interfaces are used. Entertainment, for example, cloud gaming and video streaming is another key factor in increasing the need for mobile broadband capabilities. Entertainment is essential in smartphones and tablets at anywhere including in high mobility environments such as trains, cars and airplanes. Another use case is augmented reality and information search for entertainment. Here, augmented reality requires very low latency and instantaneous amount of data.

Further, one of most anticipated 5G use cases relates to a function, i.e., mMTC that can smoothly connect embedded sensors in all fields. By 2020 year, potential IoT devices are expected to reach 20.4 billion. Industrial IoT is one of areas in which 5G plays a major role in enabling smart cities, asset tracking, smart utilities, and agriculture and security infrastructure.

URLLC includes new services to transform an industry through ultra-reliable/available low latency links, such as remote control of major infrastructure and self-driving vehicles. A level of reliability and latency is essential for smart grid control, industrial automation, robotics, drone control, and coordination.

Hereinafter, a number of use cases are described in more detail.

5G can complement fiber-to-the-home (FTTH) and cable-based broadband (or DOCSIS) as a means of providing streams that are rated at hundreds of megabits per second to gigabits per second. Such a high speed is required to deliver televisions with a resolution of 4K or more (6K, 8K, and more) as well as virtual reality and augmented reality. Virtual Reality (VR) and Augmented Reality (AR) applications include nearly immersive sporting events. A specific application program can require a special network setting. For example, for VR games, in order to minimize latency, game companies can need to integrate core servers with an edge network server of a network operator.

An automotive is expected to become important new dynamic power for 5G together with many use cases for mobile communication to vehicles. For example, entertainment for passengers requires simultaneous high capacity and high mobility mobile broadband. This is because future users continue to expect high quality connections regardless of a position and speed thereof. Another use case of an automotive sector is an augmented reality dashboard. This identifies objects in the dark above what a driver views through a front window and overlays and displays information that notifies the driver about a distance and movement of the object. In the future, wireless modules enable communication between vehicles, exchange of information between a vehicle and a supporting infrastructure, and exchange of information between a vehicle and other connected devices (e.g., devices carried by pedestrians). A safety system guides alternative courses of an action to enable drivers to safer drive, thereby reducing the risk of an accident. The next step will be a remotely controlled or self-driven vehicle. This requires very reliable and very fast communication between different self-driving vehicles and between automobiles and infrastructure. In the future, self-driving vehicles will perform all driving activities and the driver will focus on traffic anomalies that the vehicle itself cannot identify. The technical requirements of self-driving vehicles require ultra-low latency and ultra-fast reliability so as to increase traffic safety to an unachievable level.

Smart cities and smart homes, referred to as smart societies, will be embedded in a high density wireless sensor network. A distributed network of intelligent sensors will identify conditions for a cost and energy-efficient maintenance of a city or a home. Similar settings can be made for each family. Temperature sensors, window and heating controllers, burglar alarms and home appliances are all connected wirelessly. These many sensors are typically low data rates, low power and low cost. However, for example, real-time HD video can be required in a specific type of device for surveillance.

Consumption and distribution of energy including a heat or a gas is highly decentralized, thereby requiring automated control of distributed sensor networks. Smart grids interconnect these sensors using digital information and communication technology so as to collect information and act accordingly. The information can include a behavior of suppliers and consumers, allowing smart grids to improve distribution of fuels such as electricity in efficiency, reliability, economics, sustainability of production, and in an automated manner. Smart grid can be viewed as another sensor network with low latency.

A health sector has many application programs that can benefit from mobile communication. The communication system can support telemedicine that provides clinical care at a far distance. This can help reduce barriers to distance and improve access to healthcare services that are not consistently available in remote rural areas. It is also used for saving lives in important care and emergency situations. A mobile communication based wireless sensor network can provide remote monitoring and sensors for parameters such as a heart rate and a blood pressure.

Wireless and mobile communication is becoming gradually important in an industrial application field. A wiring requires a highly installing and maintaining cost. Therefore, the possibility of replacing with a wireless link that can reconfigure a cable is an attractive opportunity in many industry fields. However, achieving this requires that a wireless connection operates with reliability, capacity, and delay similar to a cable and that management is simplified. Low latency and very low error probability are new requirements that need to be connected in 5G.

Logistics and freight tracking are important use cases for mobile communication that enable tracking of inventory and packages at anywhere using a position-based information system. A use case of logistics and freight tracking typically requires a low data rate, but requires reliable position information and a wide range.

The present disclosure to be described later in the present specification can be implemented by combining or changing each embodiment so as to satisfy the requirements of the above-described 5G.

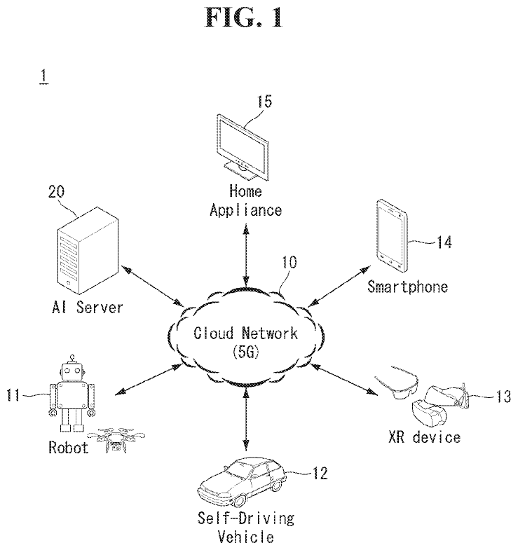

FIG. 1 is a conceptual diagram illustrating an embodiment of an AI device.

Referring to FIG. 1, in an AI system, at least one of an AI server 20, a robot 11, an autonomous vehicle 12, an XR device 13, a smartphone 14, or a home appliance 15 is connected to a cloud network 10. Here, the robot 11, the autonomous vehicle 12, the XR device 13, the smartphone 14, or the home appliance 15 to which AI technology is applied can be referred to as AI devices 11 to 15.

The cloud network 10 can mean a network that configures part of a cloud computing infrastructure or that exists inside a cloud computing infrastructure. Here, the cloud network 10 can be configured using a 3G network, a 4G network, a long term evolution (LTE) network, or a 5G network.

That is, each device 11 to 15 and 20 constituting the AI system can be connected to each other through the cloud network 10. In particular, each of the devices 11 to 15 and 20 can communicate with each other through a base station, but can directly communicate with each other without passing through a base station.

The AI server 20 can be one or more servers. and can include a server that performs AI processing and a server that performs operations on big data.

The AI server 20 can be connected to at least one of the robot 11, the autonomous vehicle 12, the XR device 13, the smartphone 14, or the home appliance 15, which are AI devices constituting the AI system through the cloud network 10 and can help at least some of AI processing of the connected AI devices 11 to 15.

In this case, the AI server 20 can learn an artificial neural network according to machine learning algorithm instead of the AI devices 11 to 15 and directly store a learning model or transmit a learning model to the AI devices 11 to 15.

In this case, the AI server 20 can receive input data from the AI devices 11 to 15, infer a result value of the input data received using a learning model, and generate a response or a control command based on the inferred result value to transmit the response or the control command to the AI devices 11 and 15.

Alternatively, the AI devices 11 to 15 can directly infer a result value of the input data using a learning model and generate a response or a control command based on the inferred result value.

<AI+Robot>

AI technology is applied to the robot 11, and the robot 11 can be implemented into a guide robot, a transport robot, a cleaning robot, a wearable robot, an entertainment robot, a pet robot, an unmanned aerial robot, or the like.

The robot 11 can include a robot control module for controlling an operation, and the robot control module can mean a software module or a chip implemented in hardware.

The robot 11 can obtain status information of the robot 11 using sensor information obtained from various kinds of sensors, detect (recognize) a surrounding environment and an object, generate map data, determine a moving route and a driving plan, determine a response to a user interaction, or determine an operation.

Here, in order to determine a movement route and a driving plan, the robot 11 can use sensor information obtained from a sensor of at least one of rider, radar, and a camera.

The robot 11 can perform the above operation using a learning model configured with at least of one artificial neural network. For example, the robot 11 can recognize a surrounding environment and an object using a learning model, and determine an operation using the recognized surrounding environment information or object information. Here, the learning model can be directly learned by the robot 11 or can be learned by an external device such as the AI server 20.

In this case, by generating a result directly using a learning model, the robot 11 can perform an operation, but can transmit sensor information to an external device such as the AI server 20 and receive the generated result and perform an operation.

The robot 11 can determine a movement route and a driving plan using at least one of map data, object information detected from sensor information, or object information obtained from an external device, and control a driver to drive the robot 11 according to the determined movement route and driving plan.

The map data can include object identification information about various objects disposed in a space in which the robot 11 moves. For example, the map data can include object identification information about fixed objects such as walls and doors and movable objects such as flower pots and desks. The object identification information can include a name, a kind, a distance, and a position.

Further, by controlling the driver based on the control/interaction of a user, the robot 11 can perform an operation or can drive. In this case, the robot 11 can obtain intention information of an interaction according to the user's motion or voice utterance, and determine a response based on the obtained intention information to perform an operation.

<AI+Autonomous Vehicle>

AI technology is applied to the autonomous vehicle 12 and thus the autonomous vehicle 12 can be implemented into a mobile robot, a vehicle, an unmanned aerial vehicle, or the like.

The autonomous vehicle 12 can include an autonomous driving control module for controlling an autonomous driving function, and the autonomous driving control module can mean a software module or a chip implemented in hardware. The autonomous driving control module can be included inside the autonomous vehicle 12 as a configuration of the autonomous vehicle 12, but can be configured as a separate hardware to be connected to the outside of the autonomous vehicle 12.

The autonomous vehicle 12 can obtain status information thereof using sensor information obtained from various types of sensors, detect (recognize) a surrounding environment and object, generate map data, determine a moving route and a driving plan, or determine an operation.

Here, in order to determine a movement route and a driving plan, the autonomous vehicle 12 can use sensor information obtained from a sensor of at least one of rider, radar, and a camera, similar to the robot 11.

In particular, the autonomous vehicle 12 can recognize an environment or an object about an area in which a field of view is covered or an area of a predetermined distance or more by receiving sensor information from external devices or can directly receive recognized information from external devices.

The autonomous vehicle 12 can perform the above-described operations using a learning model configured with at least one artificial neural network. For example, the autonomous vehicle 12 can recognize a surrounding environment and an object using a learning model, and determine a driving route using the recognized surrounding environment information or object information. Here, the learning model can be learned directly from the autonomous vehicle 12 or can be learned from an external device such as the AI server 20.

In this case, by generating a result directly using a learning model, the autonomous vehicle 12 can perform an operation, but transmit sensor information to an external device such as the AI server 20 and thus receive the generated result to perform an operation.

The autonomous vehicle 12 can determine a moving route and a driving plan using at least one of map data, object information detected from sensor information, or object information obtained from an external device, and controls the driver to drive the autonomous vehicle 12 according to the determined moving route and driving plan.

The map data can include object identification information about various objects disposed in a space (e.g., road) in which the autonomous vehicle 12 drives. For example, the map data can include object identification information about fixed objects such as street lights, rocks, buildings, and movable objects such as vehicles and pedestrians. The object identification information can include a name, a kind, a distance, a position, and the like.

Further, by controlling the driver based on a user's control/interaction, the autonomous vehicle 12 can perform an operation or can drive. In this case, the autonomous vehicle 12 can obtain intention information of an interaction according to the user's motion or voice utterance, and determine a response based on the obtained intention information to perform an operation.

<AI+XR>

AI technology is applied to the XR device 13 and thus the XR device 13 can be implemented into a head-mount display (HMD), a head-up display (HUD) installed in a vehicle, a television, a mobile phone, a smartphone, a computer, a wearable device, a home appliance, digital signage, a vehicle, a fixed robot, or a mobile robot.

The XR device 13 can analyze three-dimensional point cloud data or image data obtained through various sensors or from an external device to generate position data and attribute data of the three-dimensional points, thereby obtaining information about a surrounding space or a reality object and rendering and outputting an XR object to output. For example, the XR device 13 can output an XR object including additional information about the recognized object to correspond to the recognized object.

The XR device 13 can perform the above-described operations using a learning model configured with at least one artificial neural network. For example, the XR device 13 can recognize a real object in 3D point cloud data or image data using the learning model, and provide information corresponding to the recognized real object. Here, the learning model can be learned directly from the XR device 13 or can be learned from an external device such as the AI server 20.

In this case, by generating a result directly using a learning model, the XR device 13 can perform an operation, but transmit sensor information to an external device such as the AI server 20 and receive the generated result to perform an operation.

<AI+Robot+Autonomous Driving>

AI technology and autonomous driving technology are applied to the robot 11 and thus the robot 11 can be implemented into a guide robot, a transport robot, a cleaning robot, a wearable robot, an entertainment robot, a pet robot, an unmanned aerial robot, or the like.

The robot 11 to which AI technology and autonomous driving technology are applied can mean a robot having an autonomous driving function or a robot 11 interacting with the autonomous vehicle 12.

The robot 11 having an autonomous driving function can be collectively referred to as devices that moves by themselves according to a given moving route without a user's control or that determine and move a moving route by themselves.

In order to determine at least one of a movement route or a driving plan, the robot 11 and the autonomous vehicle 12 having an autonomous driving function can use a common sensing method. For example, the robot 11 and the autonomous vehicle 12 having the autonomous driving function can determine at least one of a movement route or a driving plan using information sensed through lidar, radar, and the camera.

While the robot 11 interacting with the autonomous vehicle 12 exists separately from the autonomous vehicle 12, the robot 11 can be linked to an autonomous driving function inside or outside the autonomous vehicle 12 or can perform an operation connected to a user who rides in the autonomous vehicle 12.

In this case, the robot 11 interacting with the autonomous vehicle 12 can obtain sensor information instead of the autonomous vehicle 12 to provide the sensor information to the autonomous vehicle 12 or can obtain sensor information and generate surrounding environment information or object information to provide the surrounding environment information or the object information to the autonomous vehicle 12, thereby controlling or assisting an autonomous driving function of the autonomous vehicle 12.

Alternatively, the robot 11 interacting with the autonomous vehicle 12 can monitor a user who rides in the autonomous vehicle 12 or can control a function of the autonomous vehicle 12 through an interaction with the user. For example, when it is determined that a driver is in a drowsy state, the robot 11 can activate an autonomous driving function of the autonomous vehicle 12 or assist the control of the driver of the autonomous vehicle 12. Here, the function of the autonomous vehicle 12 controlled by the robot 11 can include a function provided by a navigation system or an audio system provided inside the autonomous vehicle 12 as well as an autonomous driving function.

Alternatively, the robot 11 interacting with the autonomous vehicle 12 can provide information from the outside of the autonomous vehicle 12 to the autonomous vehicle 12 or assist a function of the autonomous vehicle 12. For example, the robot 11 can provide traffic information including signal information to the autonomous vehicle 12 as in a smart traffic light and interact with the autonomous vehicle 12 to automatically connect an electric charger to a charging port, as in an automatic electric charger of an electric vehicle.

<AI+Robot+Xr>

AI technology and XR technology are applied to the robot 11, and the robot 11 can be implemented into a guide robot, a transport robot, a cleaning robot, a wearable robot, an entertainment robot, a pet robot, an unmanned aerial robot, a drone, or the like.

The robot 11 to which the XR technology is applied can mean a robot to be an object of control/interaction in an XR image. In this case, the robot 11 can be distinguished from the XR device 13 and be interworked with the XR device 13.

When the robot 11 to be an object of control/interaction in the XR image obtains sensor information from sensors including a camera, the robot 11 or the XR device 13 generates an XR image based on the sensor information, and the XR device 13 can output the generated XR image. The robot 11 can operate based on a control signal input through the XR device 13 or a user interaction.

For example, the user can check an XR image corresponding to a viewpoint of the robot 11 remotely linked through an external device such as the XR device 13, and adjust an autonomous driving route of the robot 11 through an interaction, control an operation or driving of the robot 11, or check information of a surrounding object.

<AI+Autonomous Vehicle+XR>

AI technology and XR technology are applied to the autonomous vehicle 12, and the autonomous vehicle 12 can be implemented into a mobile robot, a vehicle, an unmanned aerial vehicle, and the like.

The autonomous vehicle 12 to which XR technology is applied can mean an autonomous vehicle having a means for providing an XR image or an autonomous vehicle to be an object of control/interaction in the XR image. In particular, the autonomous vehicle 12 to be an object of control/interaction in the XR image can be distinguished from the XR device 13 and be interworked with the XR device 13.

The autonomous vehicle 12 having a means for providing an XR image can obtain sensor information from sensors including a camera, and output an XR image generated based on the obtained sensor information. For example, by having an HUD and outputting an XR image, the autonomous vehicle 12 can provide an XR object corresponding to a real object or an object on a screen to an occupant.

In this case, when the XR object is output to the HUD, at least a part of the XR object can be output to overlap with the actual object to which the occupant's eyes are directed. However, when the XR object is output to the display provided inside the autonomous vehicle 12, at least a part of the XR object can be output to overlap with an object on the screen. For example, the autonomous vehicle 12 can output XR objects corresponding to objects such as a road, another vehicle, a traffic light, a traffic sign, a motorcycle, a pedestrian, a building, and the like.

When the autonomous vehicle 12 to be an object of control/interaction in the XR image obtains sensor information from sensors including a camera, the autonomous vehicle 12 or the XR device 13 can generate an XR image based on the sensor information, and the XR device 13 can output the generated XR image. The autonomous vehicle 12 can operate based on a user's interaction or a control signal input through an external device such as the XR device 13.

EXtended Reality (XR) collectively refers to Virtual Reality (VR), Augmented Reality (AR), and Mixed Reality (MR). VR technology is computer graphic technology that provides an object or a background of a real world only to CG images, AR technology is computer graphic technology that together provides virtual CG images on real object images, and MR technology is computer graphic technology that provides by mixing and combining virtual objects in a real world.

MR technology is similar to AR technology in that it shows both a real object and a virtual object. However, there is a difference in that in AR technology, a virtual object is used in the form of supplementing a real object, but in MR technology, a virtual object and a real object are used in an equivalent nature.

XR technology can be applied to a Head-Mount Display (HMD), a Head-Up Display (HUD), a mobile phone, a tablet PC, a laptop computer, a desktop computer, a television, digital signage, etc. and a device to which XR technology is applied can be referred to an XR device.

A. Example of Block Diagram of UE and 5G Network

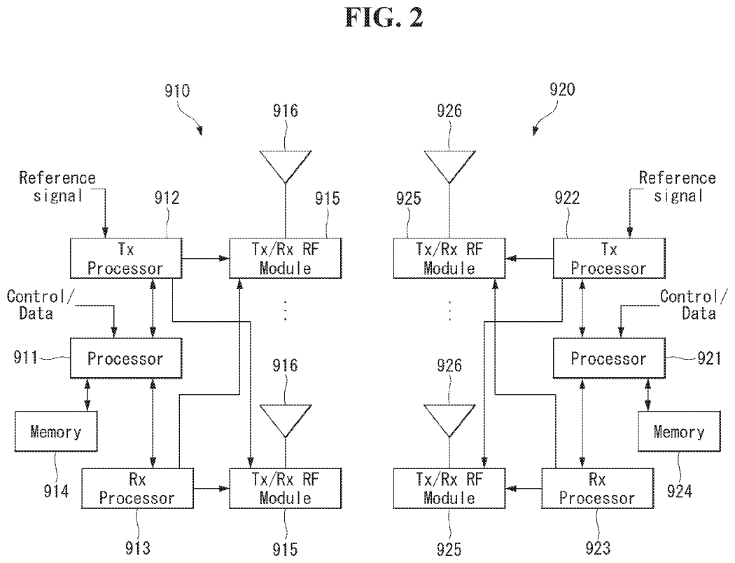

FIG. 2 is a block diagram of a wireless communication system to which methods proposed in the disclosure are applicable.

Referring to FIG. 2, a device (AI device) including an AI module is defined as a first communication device (910 of FIG. 2), and a processor 911 can perform detailed autonomous operations.

A 5G network including another device (AI server) communicating with the AI device is defined as a second communication device (920 of FIG. 2), and a processor 921 can perform detailed autonomous operations.

The 5G network can be represented as the first communication device and the AI device can be represented as the second communication device.

For example, the first communication device or the second communication device can be a base station, a network node, a transmission terminal, a reception terminal, a wireless device, a wireless communication device, an autonomous device, or the like.

For example, the first communication device or the second communication device can be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) can include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD can be a display device worn on the head of a user. For example, the HMD can be used to realize VR, AR or MR. For example, the drone can be a flying object that flies by wireless control signals without a person therein. For example, the VR device can include a device that implements objects or backgrounds of a virtual world. For example, the AR device can include a device that connects and implements objects or background of a virtual world to objects, backgrounds, or the like of a real world. For example, the MR device can include a device that unites and implements objects or background of a virtual world to objects, backgrounds, or the like of a real world. For example, the hologram device can include a device that implements 360-degree 3D images by recording and playing 3D information using the interference phenomenon of light that is generated by two lasers meeting each other which is called holography. For example, the public safety device can include an image repeater or an imaging device that can be worn on the body of a user. For example, the MTC device and the IoT device can be devices that do not require direct interference or operation by a person. For example, the MTC device and the IoT device can include a smart meter, a bending machine, a thermometer, a smart bulb, a door lock, various sensors, or the like. For example, the medical device can be a device that is used to diagnose, treat, attenuate, remove, or prevent diseases. For example, the medical device can be a device that is used to diagnose, treat, attenuate, or correct injuries or disorders. For example, the medial device can be a device that is used to examine, replace, or change structures or functions. For example, the medical device can be a device that is used to control pregnancy. For example, the medical device can include a device for medical treatment, a device for operations, a device for (external) diagnose, a hearing aid, an operation device, or the like. For example, the security device can be a device that is installed to prevent a danger that is likely to occur and to keep safety. For example, the security device can be a camera, a CCTV, a recorder, a black box, or the like. For example, the Fin Tech device can be a device that can provide financial services such as mobile payment.

Referring to FIG. 2, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 can be related to the memory 924 that stores program code and data. The memory can be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 can be related to the memory 924 that stores program code and data. The memory can be referred to as a computer-readable medium.

B. Signal Transmission/Reception Method in Wireless Communication System

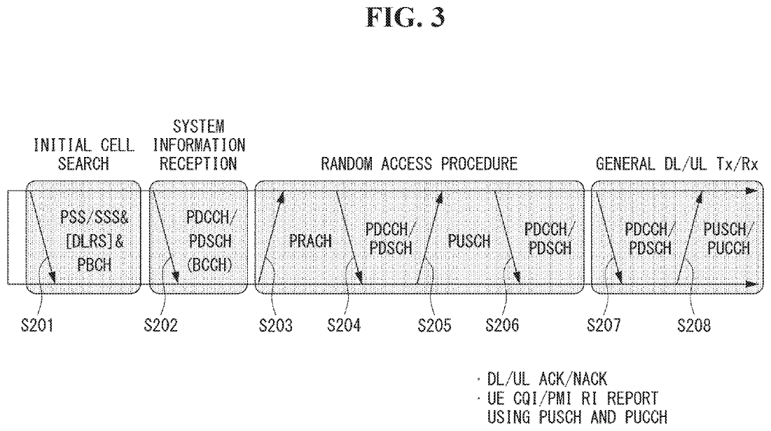

FIG. 3 is a diagram showing an example of a signal transmission/reception method in a wireless communication system.

In a wireless communication system, a UE (user equipment) receives information from a base station through downlink (DL), and the UE transmits information to the base station through uplink (UL). The information transmitted and received by the base station and the UE includes data and various control information, and various physical channels exist according to a kind/use of information in which the base station and the UE transmit and receive.

When power of the UE is turned on or when the UE newly enters to a cell, the UE performs an initial cell search operation of synchronizing with the base station (S201). For this reason, the UE can receive a primary synchronization signal (PSS) and a secondary synchronization signal (SSS) from the base station to be synchronized with the base station and obtain information such as cell ID. Thereafter, the UE can receive a physical broadcast channel (PBCH) from the base station to obtain broadcast information within the cell. The UE can receive a downlink reference signal (DL RS) in an initial cell search step to check a downlink channel status.

The UE, having finished initial cell search can receive a physical downlink shared channel (PDSCH) according to a physical downlink control channel (PDCCH) and information loaded in the PDCCH to obtain more specific system information (S202).

When the UE first accesses to the base station or when there is no radio resource for signal transmission, the UE can perform a random access procedure (RACH) to the base station (S203 to S206). For this reason, the UE can transmit a specific sequence to a preamble through a physical random access channel (PRACH) (S203 and S205) and receive a random access response (RAR) message to the preamble through the PDCCH and the PDSCH corresponding thereto. In the case of a contention-based RACH, the UE can additionally perform a contention resolution procedure (S206).

The UE, having performed the above process can perform PDCCH/PDSCH reception (S207) and physical uplink shared channel (PUSCH)/physical uplink control channel (PUCCH) transmission (S208) as a general uplink/downlink signal transmission procedure. In particular, the UE receives downlink control information (DCI) through the PDCCH. Here, the DCI includes control information such as resource allocation information for the UE and can be applied in different formats according to a use purpose.

Control information transmitted by the UE to the base station through uplink or received by the UE from the base station can include a downlink/uplink ACK/NACK signal, a channel quality indicator (CQI), a precoding matrix index (PMI), and a rank indicator (RI). The UE can transmit control information such as the above-described CQI/PMI/RI through a PUSCH and/or a PUCCH.

The UE monitors a set of PDCCH candidates at monitoring occasions set to at least one control element sets (CORESETs) on a serving cell according to the corresponding search space configurations. A set of PDCCH candidates to be monitored by the UE is defined in terms of search space sets, and the search space sets can be a common search space set or a UE-specific search space set. The CORESET is configured with a set of (physical) resource blocks having time duration of 1 to 3 OFDM symbols. The network can set the UE to have a plurality of CORESETs. The UE monitors PDCCH candidates in at least one search space sets. Here, monitoring means attempting to decode the PDCCH candidate(s) in the search space. When the UE succeeds in decoding one of PDCCH candidates in a search space, the UE determines that the PDCCH has been detected in the corresponding PDCCH candidate, and performs PDSCH reception or PUSCH transmission based on DCI in the detected PDCCH. The PDCCH can be used for scheduling DL transmissions on the PDSCH and UL transmissions on the PUSCH. Here, DCI on the PDCCH includes a downlink assignment (i.e., downlink grant (DL grant)) including at least modulation and coding format and resource allocation information related to a downlink shared channel or uplink grant (UL grant) including modulation and coding format and resource allocation information related to an uplink shared channel.

An initial access (IA) procedure in a 5G communication system will be additionally described with reference to FIG. 3.

The UE can perform cell search, system information acquisition, beam alignment for initial access, and DL measurement on the basis of an SSB (synchronization signal block). The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB can be referred to as remaining minimum system information. The MIB includes information/parameter for monitoring a PDCCH that schedules a PDSCH carrying SIB1 (SystemInformationBlockl) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 3.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-S SB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-T eD’ is applicable, the UE can assume that the CSI-RS and the SSB are quasi co-located (QCL) from the viewpoint of ‘QCL-TypeD’. Here, QCL-TypeD can mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) can frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication can also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) returning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Using 5G Communication

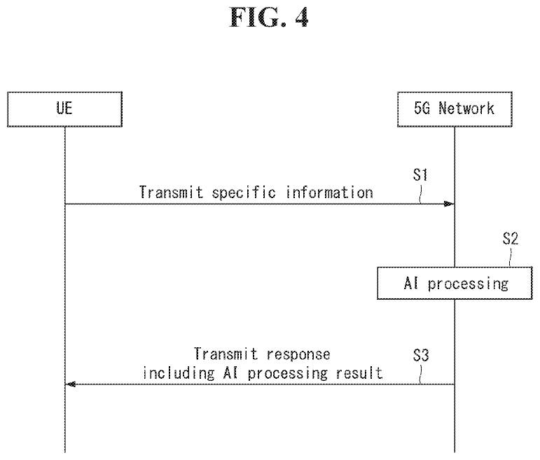

FIG. 4 shows an example of basic operations of an UE and a 5G network in a 5G communication system.

The UE transmits specific information to the 5G network (S1). The 5G network can perform 5G processing related to the specific information (S2). Here, the 5G processing can include AI processing. And the 5G network can transmit response including AI processing result to UE(S3).

G. Applied Operations Between UE and 5G Network in 5G Communication System

Hereinafter, the operation of an AI using 5G communication will be described in more detail with reference to wireless communication technology (BM procedure, URLLC, mMTC, etc.) described in FIGS. 2 and 3.

First, a basic procedure of an applied operation to which a method proposed by the present disclosure which will be described later and eMBB of 5G communication are applied will be described.

As in steps S1 and S3 of FIG. 4, the UE performs an initial access procedure and a random access procedure with the 5G network prior to step S1 of FIG. 4 in order to transmit/receive signals, information and the like to/from the 5G network.

More specifically, the UE performs an initial access procedure with the 5G network on the basis of an SSB in order to acquire DL synchronization and system information. A beam management (BM) procedure and a beam failure recovery procedure can be added in the initial access procedure, and quasi-co-location (QCL) relation can be added in a process in which the UE receives a signal from the 5G network.

In addition, the UE performs a random access procedure with the 5G network for UL synchronization acquisition and/or UL transmission. The 5G network can transmit, to the UE, a UL grant for scheduling transmission of specific information. Accordingly, the UE transmits the specific information to the 5G network on the basis of the UL grant. In addition, the 5G network transmits, to the UE, a DL grant for scheduling transmission of 5G processing results with respect to the specific information. Accordingly, the 5G network can transmit, to the UE, information (or a signal) related to remote control on the basis of the DL grant.

Next, a basic procedure of an applied operation to which a method proposed by the present disclosure which will be described later and URLLC of 5G communication are applied will be described.

As described above, an UE can receive DownlinkPreemption IE from the 5G network after the UE performs an initial access procedure and/or a random access procedure with the 5G network. Then, the UE receives DCI format 2_1 including a preemption indication from the 5G network on the basis of DownlinkPreemption IE. The UE does not perform (or expect or assume) reception of eMBB data in resources (PRBs and/or OFDM symbols) indicated by the preemption indication. Thereafter, when the UE needs to transmit specific information, the UE can receive a UL grant from the 5G network.

Next, a basic procedure of an applied operation to which a method proposed by the present disclosure which will be described later and mMTC of 5G communication are applied will be described.

Description will focus on parts in the steps of FIG. 4 which are changed according to application of mMTC.

In step S1 of FIG. 4, the UE receives a UL grant from the 5G network in order to transmit specific information to the 5G network. Here, the UL grant can include information on the number of repetitions of transmission of the specific information and the specific information can be repeatedly transmitted on the basis of the information on the number of repetitions. That is, the UE transmits the specific information to the 5G network on the basis of the UL grant. Repetitive transmission of the specific information can be performed through frequency hopping, the first transmission of the specific information can be performed in a first frequency resource, and the second transmission of the specific information can be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

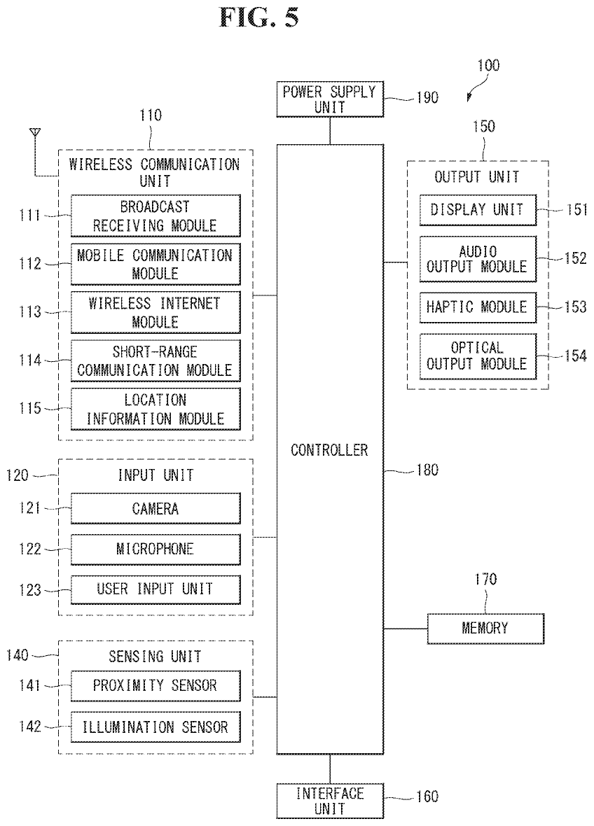

FIG. 5 is a block diagram illustrating a mobile terminal related to the present disclosure.

Referring to FIG. 5, a mobile terminal 100 can include a wireless communication unit 110, an input unit 120, a sensing unit 140, an output unit 150, an interface unit 160, a memory 170, a controller 180, and a power supply unit 190. The components shown in FIG. 5 are not essential to implementing a mobile terminal and thus a mobile terminal described in the present description can have more or fewer components than those listed above.

More specifically, among the components, the wireless communication unit 110 can include at least one module that enables wireless communication between the mobile terminal 100 and the wireless communication system, between the mobile terminal 100 and another mobile terminal 100, or between the mobile terminal 100 and an external server. Further, the wireless communication unit 110 can include at least one module for connecting the mobile terminal 100 to at least one 5G network. A detailed description thereof has been described in detail with reference to FIGS. 1 to 4, and thus a description thereof will be omitted.

The wireless communication unit 110 can include at least one of a broadcast receiving module 111, a mobile communication module 112, a wireless Internet module 113, a short-range communication module 114, and a position information module 115.

The input unit 120 can include a camera 121 or an image input unit for inputting an image signal, a microphone 122 for inputting an audio signal, an audio input unit, or a user input unit 123, for example, a touch key and a mechanical key for receiving information from a user. Audio data or image data collected by the input unit 120 can be analyzed and be processed as a control command of the user.

The sensing unit 140 can include at least one sensor for sensing at least one of information in the mobile terminal, surrounding environment information enclosing the mobile terminal, and user information. For example, the sensing unit 140 can include at least one of a proximity sensor 141, an illumination sensor 142, a touch sensor, an acceleration sensor, a magnetic sensor, a gravity sensor (G-sensor), a gyroscope sensor, a motion sensor, a red, green, and blue (RGB) sensor, an infrared sensor (IR sensor), a fingerprint scan sensor, an ultrasonic sensor, an optical sensor (e.g., the camera 121), a microphone 122, a battery gauge, an environment sensor (e.g., barometer, hygrometer, thermometer, radiation detection sensor, thermal detection sensor, gas detection sensor), a chemical sensor (e.g., electronic nose, healthcare sensor, biometric recognition sensor). The mobile terminal disclosed in the present specification can utilize a combination of information detected by at least two or more of these sensors.

The output unit 150 generates an output related to sight, hearing, or tactile sense, and can include at least one of a display unit 151, an audio output unit 152, a haptic module 153, and a light output unit 154. The display unit 151 can form a mutual layer structure with the touch sensor or can be integrally formed with the touch sensor, thereby implementing a touch screen. The touch screen can provide an output interface between the mobile terminal 100 and the user while functioning as the user input unit 123 that provides an input interface between the mobile terminal 100 and the user.

The interface unit 160 serves as a path to various types of external devices connected to the mobile terminal 100. The interface unit 160 can include at least one of a wired/wireless headset port, an external charger port, a wired/wireless data port, a memory card port, a port that connects a device equipped with an identification module, an audio input/output (I/O) port, a video input/output (I/O) port, and an earphone port. In the mobile terminal 100, the appropriate control related to a connected external device can be performed according to the external device connected to the interface unit 160.

Further, the memory 170 stores data that support various functions of the mobile terminal 100. The memory 170 can store a plurality of application programs or applications driven in the mobile terminal 100, data for operating the mobile terminal 100, and instructions. At least some of these application programs can be downloaded from an external server through wireless communication. Further, at least some of these application programs can exist on the mobile terminal 100 from the time of launching for basic functions (e.g., a call receiving or transmitting function, a message receiving or transmitting function) of the mobile terminal 100. The application program can be stored in the memory 170, installed on the mobile terminal 100, and driven by the controller 180 to perform an operation (or function) of the mobile terminal.

In addition to the operation related to the application program, the controller 180 typically controls an overall operation of the mobile terminal 100. By processing signals, data, information, and the like, which are input or output through the above-described components or by driving an application program stored in the memory 170, the controller 180 can provide or process information or a function appropriate to a user.

Further, in order to drive an application program stored in the memory 170, the controller 180 can control at least some of the components described with reference to FIG. 5. Further, in order to drive the application program, the controller 180 can combine and operate at least two or more of the components included in the mobile terminal 100.

The power supply unit 190 receives power from an external power source and an internal power source under the control of the controller 180 to supply power to each component included in the mobile terminal 100. The power supply unit 190 includes a battery, which can be a built-in battery or a replaceable battery.

In order to implement an operation, control, or control method of the mobile terminal according to various embodiments described below, at least some of the components can operate in cooperation with each other. Further, the operation, control, or control method of the mobile terminal can be implemented on the mobile terminal by driving at least one application program stored in the memory 170.

The display unit 151 displays (outputs) information processed by the mobile terminal 100. For example, the display unit 151 can display execution screen information of an application program driven in the mobile terminal 100 or user interface (UI) and graphical user interface (GUI) information according to the execution screen information.

The display unit 151 can include at least one of a liquid crystal display (LCD), a thin film transistor-liquid crystal display (TFT LCD), an organic light-emitting diode (OLED), a flexible display, a three-dimensional display (3D display), and an e-ink display.

Further, there can be two or more display units 151 according to an implementation form of the mobile terminal 100. In this case, in the mobile terminal 100, a plurality of display units can be separated at one surface or can be integrally disposed, and at different surfaces, each display unit can be disposed.

In order to receive a control command by a touch method, the display unit 151 can include a touch sensor that detects a touch on thereon. Using this, when a touch is performed on the display unit 151, the touch sensor can detect the touch, and the controller 180 can generate a control command corresponding to the touch based on the touch. The content input by the touch method can be texts or numbers or menu items that can be instructed or designated in various modes.

The touch sensor can be configured in a form of a film having a touch pattern and be disposed between a window and a display on a rear surface of the window or can be a metal wire directly patterned on the rear surface of the window. Alternatively, the touch sensor can be formed integrally with the display. For example, the touch sensor can be disposed on a substrate of the display or can be provided inside the display.

In this way, the display unit 151 can form a touch screen together with the touch sensor, and in this case, the touch screen can function as the user input unit 123. In some cases, the touch screen can replace at least some functions of a first manipulation unit.

The first sound output unit can be implemented into a receiver for transmitting a call sound to the user's ear, and the second sound output unit can be implemented in the form of a loud speaker that outputs various alarm sounds or reproduction sounds of multimedia.

A sound hole for emitting a sound generated from the first sound output unit can be formed in the window of the display unit 151. However, the present disclosure is not limited thereto, and the sound can be emitted along an assembly gap between the structures (e.g., a gap between the window and the front case). In this case, an independently formed hole for sound output can be externally invisible or hidden, thereby more simplifying an external shape of the mobile terminal 100.

The light output unit 154 can be configured to output light for notifying when an event occurs. Examples of the event can include message reception, call signal reception, missed call, alarm, schedule notification, email reception, information reception through an application, and the like. When the user's event check is detected, the controller 180 can control the light output unit 154 so as to end the light output.

The first camera processes an image frame of still pictures or moving pictures obtained by image sensors in an audiovisual call mode or a photographing mode. The processed image frames can be displayed on the display unit 151 and be stored in the memory 170.

The first to third manipulation units can be collectively referred to as a manipulating portion as an example of the user input unit 123 manipulated to receive a command for controlling an operation of the mobile terminal 100. The first to third manipulation units can be employed in any manner as long as the user manipulates with a tactile feeling such as touch, push, scroll, and the like. Further, the first and second manipulation units can be employed in such a manner that the first and second manipulation units operate without a tactile feeling of the user through a proximity touch, a hovering touch, or the like. The third manipulation unit can include a fingerprint recognition sensor to obtain a user's fingerprint. The obtained fingerprint information can be provided to the controller 180.

In the drawing, the first manipulation unit is illustrated as being a touch key, but the present disclosure is not limited thereto. For example, the first manipulation unit can be a mechanical key or can be configured with a combination of a touch key and a mechanical key.

The contents input by the first and second manipulation units can be variously set. For example, the first manipulation unit can receive a command such as a menu, a home key, a cancellation, a search, etc., and the second manipulation unit can receive adjustment in a volume of a sound output from the first or second sound output unit and a command such as switching to a touch recognition mode of the display unit 151.

As another example of the user input unit 123, a third manipulation unit can be provided at the rear surface of the terminal body. The third manipulation unit is manipulated to receive a command for controlling an operation of the mobile terminal 100, and the input content can be variously set.

For example, commands such as power on/off, start, end, and scrolling and commands such as adjustment in a volume of a sound output from the first and second sound output units, switching to a touch recognition mode of the display unit 151, and fingerprint information acquisition can be received. The rear input unit can be implemented in a form of a touch input, a push input, or an input by a combination thereof.

The rear input unit can be disposed to overlap with the front display unit 151 in a thickness direction of the terminal body. For example, the rear input unit can be disposed at the upper end of a rear surface of the terminal body so that the user can easily manipulate the terminal using an index finger when the user grips the terminal body with one hand. However, the present disclosure is not necessarily limited thereto, and a position of the rear input unit can be changed.

In this way, when the rear input unit is provided at the rear surface of the terminal body, a new type user interface using the rear input unit can be implemented. Further, when the above-described touch screen or rear input unit replaces at least some functions of the first manipulation unit provided in the front surface of the terminal body and the first manipulation unit is not disposed at the front surface of the terminal body, the display unit 151 can be configured in a larger surface.

The mobile terminal 100 can be provided with a fingerprint recognition sensor for recognizing a user's fingerprint, and the controller 180 can use fingerprint information detected through the fingerprint recognition sensor as an authentication means. The fingerprint recognition sensor can be embedded in the display unit 151 or the user input unit 123.

The microphone 122 can be configured to receive a user's voice, other sounds, and the like. The microphone 122 can be provided at a plurality of positions and be configured to receive a stereo sound.

The interface unit 160 serves as a path for connecting the mobile terminal 100 to an external device. For example, the interface unit 160 can be at least one of a connection terminal for connecting to another device (e.g., an earphone or an external speaker), a port (e.g., infrared port (IrDA Port), Bluetooth port, or a wireless LAN port) for short-range communication, or a power supply terminal for supplying power to the mobile terminal 100. The interface unit 160 can be implemented in the form of a socket for receiving an external card such as a subscriber identification module (SIM), a user identity module (UIM), or a memory card for storing information.

The second camera can be disposed at the rear surface of the terminal body. In this case, a second camera 121b has a photographing direction substantially opposite to that of the first camera.

The second camera can include a plurality of lenses arranged along at least one line. The plurality of lenses can be arranged in a matrix format. Such a camera can be referred to as an “array camera.” When the second camera is configured as an array camera, the plurality of lenses can be used to photograph images in various ways, and images of a better quality can be obtained.

A flash 124 can be disposed adjacent to the second camera. When a subject is photographed by the second camera, the flash 124 emits light toward the subject.

The second sound output unit can be additionally disposed in the terminal body. The second sound output unit can implement a stereo function together with the first sound output unit, and can be used for implementing a speakerphone mode during a call.

The terminal body can be provided with at least one antenna for wireless communication. The antenna can be built in the terminal body or can be formed in the case. For example, an antenna that forms part of the broadcast receiving module 111 (see FIG. 5) can be configured to be pulled out from the terminal body. Alternatively, the antenna can be formed in a film type to be attached to an inner side surface of the rear cover 103 or can be configured such that a case including a conductive material functions as an antenna.

The terminal body is provided with the power supply unit 190 (see FIG. 5) for supplying power to the mobile terminal 100. The power supply unit 190 can include a battery 191 embedded in the terminal body or detachably configured from the outside of the terminal body.

The battery 191 can be configured to receive power through a power cable connected to the interface unit 160. Further, the battery 191 can be configured to enable wireless charging through a wireless charger. The wireless charging can be implemented by a magnetic induction method or a resonance method (magnetic resonance method).

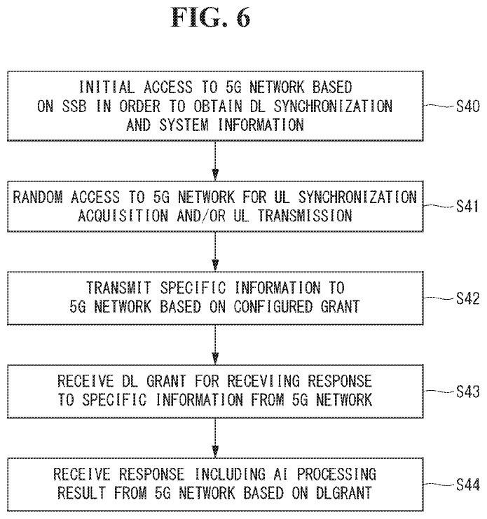

FIG. 6 illustrates an example of an operation of a user terminal (or user equipment) using 5G communication.

Next, referring to FIG. 6, the user terminal or UE (user equipment) performs an initial access procedure with the 5G network based on SSB (synchronization signal block) to obtain DL synchronization and system information (S40).

Then, the UE performs a random access procedure with the 5G network for UL synchronization acquisition and/or UL transmission (S41).

Then, the UE transmits the specific information to the 5G network based on a configured grant (S42). A procedure for configuring the grant in place of receiving the UL grant from the 5G network will be described in more detail below.

Then, the UE receives a DL grant for receiving a response to the specific information from the 5G network (S43).

Then, the UE receives the response including the AI processing result from the 5G network based on the DL grant (S44).

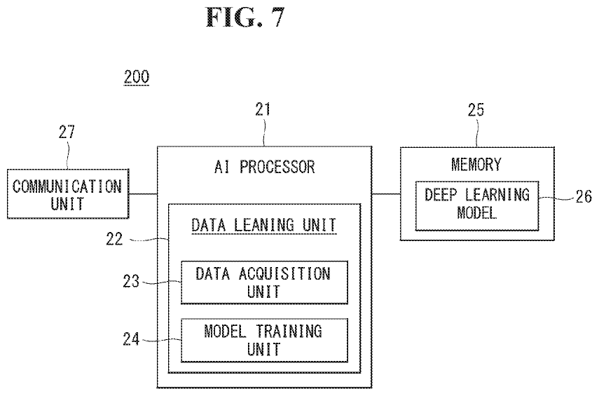

FIG. 7 is a block diagram illustrating an AI device according to an embodiment of the present disclosure.

Referring to FIG. 7, an AI device 200 can include an electronic device including an AI module that can perform AI processing or a server including the AI module. Further, the AI device 200 can be included as at least some components of the mobile terminal 100 of FIG. 5 to together perform at least some of AI processing.

The AI processing can include all operations related to the control of the mobile terminal 100 shown in FIG. 5. For example, by performing AI processing of sensing data or obtained data, the mobile terminal 100 can perform processing/determination and control signal generation operations. Further, for example, the mobile terminal 100 can perform AI processing of data received through the communication unit to perform the control of the mobile terminal 100.

The AI device 200 can include an AI processor 21, a memory 25 and/or a communication unit 27.

The AI processor 21 is a computing device that can learn a neural network and can be implemented into various electronic devices such as a server, a desktop PC, a notebook PC, and a tablet PC.

The AI processor 21 can learn a neural network using a program stored in the memory 25. In particular, the AI processor 21 can learn a neural network for recognizing data related to the mobile terminal 100. Here, the neural network for recognizing data related to the mobile terminal 100 can be designed to simulate a human brain structure on a computer and include a plurality of network nodes having a weight and simulating a neuron of the human neural network. The plurality of network modes can give and receive data according to each connection relationship so as to simulate a synaptic activity of neurons that send and receive signals through a synapse. Here, the neural network can include a deep learning model developed in the neural network model. In the deep learning model, while a plurality of network nodes is positioned in different layers, the plurality of network nodes can send and receive data according to a convolution connection relationship. An example of the neural network model includes various deep learning techniques such as deep neural networks (DNN), convolutional deep neural networks (CNN), Recurrent Boltzmann Machine (RNN), Restricted Boltzmann Machine (RBM), deep belief networks (DBN), and a deep Q-network and can be applied to the field of computer vision, speech recognition, natural language processing, and voice/signal processing.

The processor for performing the above-described functions can be a general-purpose processor (e.g., central processing unit (CPU)), but can be an AI dedicated processor (e.g., graphics processing unit (GPU)) for learning AI.

The memory 25 can store various programs and data necessary for an operation of the AI device 200. The memory 25 can be implemented into a non-volatile memory, a volatile memory, a flash memory, a hard disk drive (HDD), or a solid state drive (SDD) and the like. The memory 25 can be accessed by the AI processor 21 and read/write/modify/delete/update of data can be performed by the AI processor 21. Further, the memory 25 can store a neural network model (e.g., a deep learning model 26) generated through learning algorithm for data classification/recognition according to an embodiment of the present disclosure.

The AI processor 21 can include a data learning unit 22 for learning a neural network for data classification/recognition. The data learning unit 22 can learn learning data to use in order to determine data classification/recognition and a criterion for classifying and recognizing data using learning data. By obtaining learning data to be used for learning and applying the obtained learning data to a deep learning model, the data learning unit 22 can learn a deep learning model.

The data learning unit 22 can be produced in at least one hardware chip form to be mounted in the AI device 200. For example, the data learning unit 22 can be produced in a dedicated hardware chip form for artificial intelligence (AI) and can be produced in a part of a general-purpose processor (e.g., CPU) or a graphic dedicated processor (e.g., GPU) to be mounted in the AI device 200. Further, the data learning unit 22 can be implemented into a software module. When the data learning unit 22 is implemented into a software module (or program module including an instruction), the software module can be stored in non-transitory computer readable media. In this case, at least one software module can be provided by an Operating System (OS) or can be provided by an application.

The data learning unit 22 can include a learning data acquisition unit 23 and a model learning unit 24.

The learning data acquisition unit 23 can obtain learning data necessary for a neural network model for classifying and recognizing data. For example, the learning data acquisition unit 23 can obtain data and/or sample data of the mobile terminal 100 for inputting as learning data to the neural network model.

The model learning unit 24 can learn to have a determination criterion in which a neural network model classifies predetermined data using the obtained learning data. In this case, the model learning unit 24 can learn a neural network model through supervised learning that uses at least a portion of the learning data as a determination criterion. Alternatively, the model learning unit 24 can learn the neural network model through unsupervised learning that finds a determination criterion by self-learning using learning data without supervision. Further, the model learning unit 24 can learn the neural network model through reinforcement learning using feedback on whether a result of situation determination according to learning is correct. Further, the model learning unit 24 can learn the neural network model using learning algorithm including error back-propagation or gradient decent.

When the neural network model is learned, the model learning unit 24 can store the learned neural network model in the memory. The model learning unit 24 can store the learned neural network model at the memory of the server connected to the AI device 200 by a wired or wireless network.

In order to improve an analysis result of a recognition model or to save a resource or a time necessary for generation of the recognition model, the data learning unit 22 can further include a learning data pre-processor and a learning data selecting unit.

The learning data pre-processor can pre-process obtained data so that the obtained data can be used in learning for situation determination. For example, the learning data pre-processor can process the obtained data in a predetermined format so that the model learning unit 24 uses obtained learning data for learning for image recognition.

Further, the learning data selection unit can select data necessary for learning among learning data obtained from the learning data acquisition unit 23 or learning data pre-processed in the pre-processor. The selected learning data can be provided to the model learning unit 24. For example, by detecting a specific area of an image obtained through a camera of the mobile terminal 100, the learning data selection unit can select only data of an object included in the specified area as learning data.

Further, in order to improve an analysis result of the neural network model, the data learning unit 22 can further include a model evaluation unit.

The model evaluation unit inputs evaluation data to the neural network model, and when an analysis result output from evaluation data does not satisfy predetermined criteria, the model evaluation unit can enable the model learning unit 24 to learn again. In this case, the evaluation data can be data previously defined for evaluating a recognition model. For example, when the number or a proportion of evaluation data having inaccurate analysis results exceeds a predetermined threshold value among analysis results of a learned recognition model of evaluation data, the model evaluation unit can evaluate evaluation data as data that do not satisfy predetermined criteria.

The communication unit 27 can transmit an AI processing result by the AI processor 21 to an external electronic device.

It has been described that the AI device 200 of FIG. 7 is functionally divided into the AI processor 21, the memory 25, and the communication unit 27, but the above-mentioned components can be integrated into a single module to be referred to as an AI module.

Recently, with the development of information and communication technology, diversification and functions of smartphones have been much improved. Accordingly, spread of smartphones has been rapidly progressed, and more than one smartphone per person is being distributed.

With the spread of smartphones, in a specific situation, a situation has occurred in which notification providing is required through a notification setting appropriate to the situation, and there has been inconvenience in that a user should change a notification setting each time in a specific situation for an appropriate notification setting and there was a problem that a case occurs in which the user does not change the notification setting by an error.

In the present specification, in order to solve the above-described inconvenience and problem, a method is proposed in which the smartphone recognizes a surrounding situation to provide a notification through notification setting appropriate to the surrounding situation.

Hereinafter, the smartphone described in the present specification can be used interchangeably with the terminal.

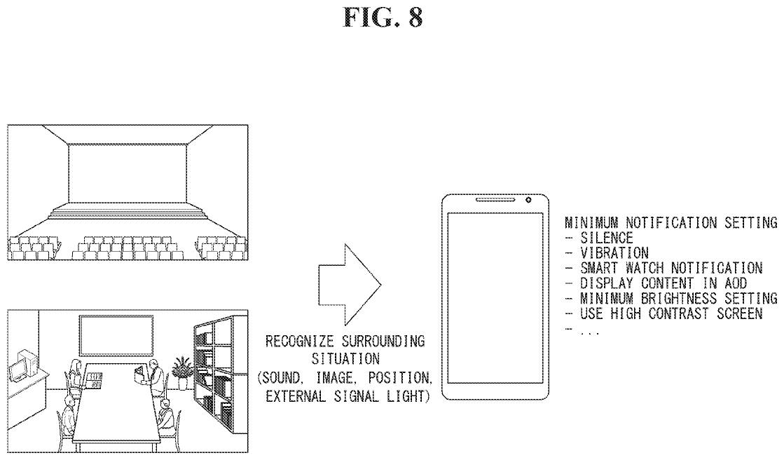

FIG. 8 illustrates an example of an operation in which a notification providing method proposed in the present specification is performed according to an embodiment of the present invention. All the methods and operations of the present invention can be implemented using one or more device(s) and/or system(s) of the present invention.

Referring to FIG. 8, the smartphone can detect a surrounding situation in a specific situation. For example, the smartphone can detect a surrounding situation so as to determine whether the smartphone is currently in a library or a movie theater.

The smartphone can recognize a surrounding situation based on the detection result of such a situation. In this case, in order to recognize the surrounding situation, the smartphone can detect a sound, an image, a position, an external signal, and the like through a plurality of sensors installed therein and recognize the surrounding situation through the detected result.

In other words, the smartphone can recognize/identify a surrounding situation of a position in which the smartphone is currently positioned based on the detected surrounding situation using a plurality of sensors.

For example, when a smartphone detects a movie screen, a plurality of seats, a plurality of people, a dark environment, etc. using a plurality of sensors, the smartphone can recognize that the current situation is inside a movie theater.

As another example, when the smartphone detects a plurality of books using a plurality of sensors and detects a very small sound or cannot detect ambient noise, the smartphone can recognize that the current situation is inside the library.

Thereafter, the smartphone can change the notification setting of the smartphone based on a preset notification setting and provide a notification according to the changed notification setting.

In this case, the notification setting can include one or more of silence, a vibration, a smart watch notification, always on display (AOD), minimum brightness, and high contrast screen.

For example, when the smartphone recognizes that the current surrounding situation is inside the library, the inside of the library is sensitive to noise and thus silence or a vibration notification can be set.

Further, when the smartphone recognizes that the current surrounding situation is inside a movie theater, at the inside of the movie theater, the smartphone is sensitive to brightness at a position other than the screen and is sensitive to ambient noise and thus silence or a vibration notification can be set and a minimum brightness setting can be additionally performed.

Therefore, the smartphone recognizes a surrounding situation by itself and sets a notification operation mode, thereby enabling the user to observe the rules of etiquette by setting the notification operation mode so as not to disturb the surroundings.

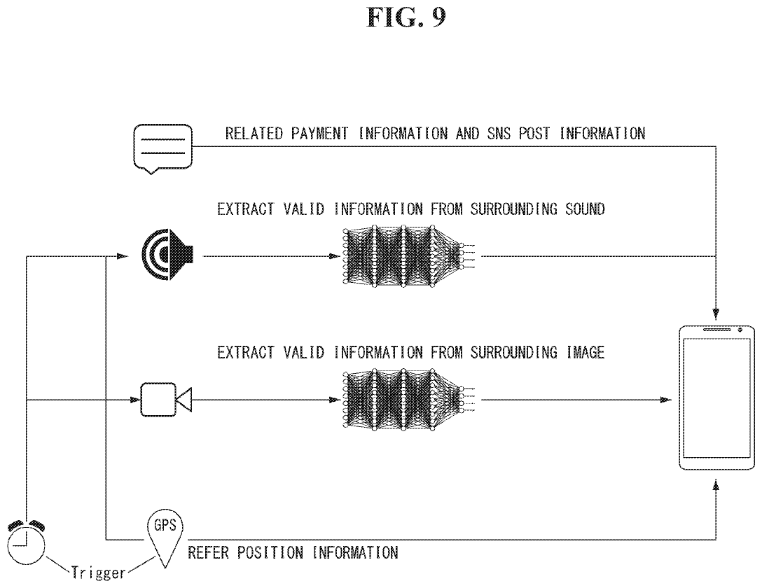

FIG. 9 illustrates an example of an operation in which a notification providing method proposed in the present specification is performed using information detected through a sensor unit according to an embodiment of the present invention.

Hereinafter, a method in which information collection for recognizing a surrounding situation is performed through the sensor unit will be described with reference to FIG. 9.

Various sensors built into the smartphone can be used for detecting a surrounding situation of a position in which the smartphone is positioned. The surrounding situation can be recognized based on the detected surrounding situation.

In consideration of the recognized surrounding situation, a notification setting to provide a notification can be determined.

In this case, a detection object to be detected by various sensors will be described.

The sensor installed in the smartphone can detect position information, and when the smartphone is positioned at a periphery of a specific place through the detected position information, the smartphone can provide a notification setting appropriate to the specific place. In this case, the position information can periodically, i.e., at specific time intervals detect position (place) information and recognize a surrounding environment.

Further, by collecting/detecting position information and payment information related to a current time, the sensor installed in the smartphone can recognize a surrounding environment.

For example, the smartphone can detect payment information in which a user of the smartphone paid a movie ticket at a movie theater and compare a present time and position information with a movie running time, movie theater (place), etc. included in the payment information to recognize that a surrounding environment, i.e., the user of the smartphone is inside the movie theater. Additionally, in order to determine whether the user is inside a movie theater, the smartphone can use a sensor for detecting a sound and/or a sensor for detecting an image.

For example, by recognizing a position of a current user (smartphone) by comparing payment information with a current time and position information, the smartphone can additionally recognize a more accurate position (surrounding situation) of a user (smartphone) using a sensor for detecting a sound and/or a sensor for detecting an image.

Further, the sensor installed in the smartphone can detect schedule information input by the user with an application installed in the smartphone to identify position information and recognize a current surrounding situation.

For example, when the user inputs information about a specific day of the week, a specific time, and a specific place as a schedule, the sensor installed in the smartphone can recognize a current surrounding situation in consideration of the schedule information, the time information, the day of the week information, etc. in a comprehensive manner. Specifically, when the user inputs a schedule such as “room 1 at 3 pm on Jul. 26, 2019” to a smartphone application for a meeting, the smartphone can identify the schedule information and change to the preset notification setting at 3 pm on Jul. 26, 2019. Further, additionally, in order to determine whether the user is actually positioned in a conference room at a designated time (3 pm on Jul. 26, 2019), the smartphone can additionally use a sensor for detecting a sound and/or a sensor for detecting an image.

For example, it can be determined whether a meeting is currently in progress using a sensor for detecting a sound, and it can be additionally determined whether a position is a conference room through a sensor for detecting an image. In this case, when it is determined that the user is not in a conference room, the smartphone can maintain an existing notification setting without changing.

Further, by detecting/collecting information of a Social Network Service (SNS) post related to a user account of the smartphone, the sensor installed in the smartphone can recognize a current surrounding situation.

For example, when the user of the smartphone uploads a post such as “Watching a movie at 2 pm on Jul. 27, 2019,” on an SNS, the smartphone can detect this and change a notification setting to a preset notification corresponding to a movie theater at “2 pm on Jul. 27, 2019.”

In this case, in order to additionally determine whether the user is positioned in a movie theater, a sensor for detecting a sound and/or a sensor for detecting an image can be used and a detailed description thereof is described as described above.

Further, the sensor installed in the smartphone can detect sound information, and the detected sound information can be classified into and detected to noise, space, and sound kind.

For example, it can be distinguished whether the detected sound is a sound detected in a closed space or a sound detected in an open space, and it can be distinguished whether the detected sound is an animal sound, a wind sound, or a human sound.

In this case, in order to distinguish the detected sound information into noise, space, and sound type, Deep Neural Network (DNN) learning can be used and only valid information can be extracted from the detected sound through the DNN learning and thus a sound can be distinguished.

Further, the sensor installed in the smartphone can detect image information, and identify and recognize brightness, a color, an object, and a place in the detected image.

DNN learning (e.g., see FIG. 11) can be used for identifying and recognizing brightness, a color, an object, and a place through the detected image information.

Further, in order to detect the above-described position information, a GPS sensor can be used, and sensors can be triggered through position information and time information based on the GPS sensor.

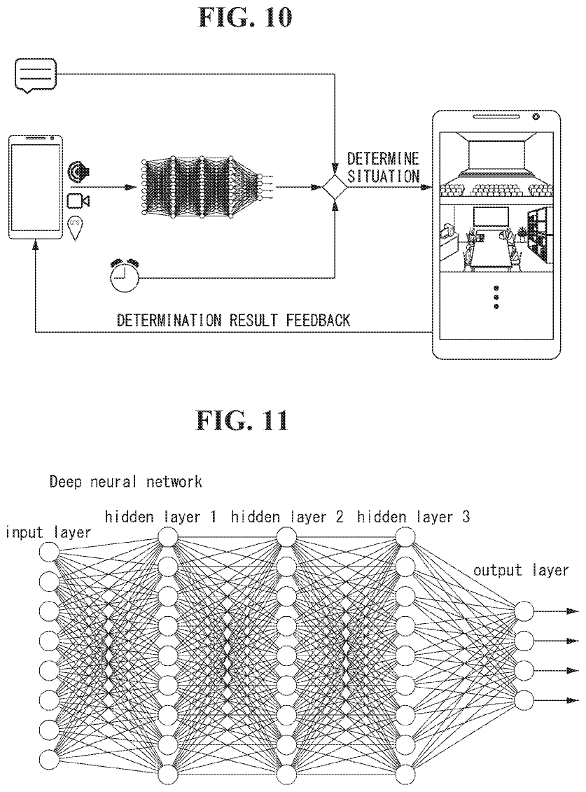

FIG. 10 is a diagram illustrating a feedback method of a notification providing method proposed in the present specification.

Referring to FIG. 10, in consideration of information detected by the above-described sensors, it is possible to recognize a surrounding situation of a position in which the smartphone is currently positioned and a notification setting can be provided accordingly.

In this case, the detected information and information on the recognized surrounding situation can be fed back and stored in a smartphone internal device.

That is, the result of the detected information and the recognized surrounding situation can be added to a separate inference model in the form of feedback, and accuracy can be improved by learning the inference model.

In this case, the above DNN learning can be used as a learning method.

Therefore, there is an effect that an optimal notification setting is possible for each surrounding situation/environment.

For example, by inputting all information collected through a plurality of sensors, the smartphone can recognize and identify a current place and a surrounding situation.

The notification setting can be available according to the recognized surrounding situation. Table 1 shows an example of setting a notification considering the surrounding situation.

TABLE 1

| Surrounding | | | Screen | Screen | |
|---|---|---|---|---|---|
| situation | Sound | Vibration | brightness | setting | Remark |
| Movie | Silence | Vibration | Minimum | High | Use AOD |
| theater | | | | contrast | screen. |
| | | | | inversion | When |
| | | | | | wearable |
| | | | | | device is |
| | | | | | used, |
| | | | | | vibration |
| | | | | | is |
| | | | | | set to only |
| | | | | | wearable |
| | | | | | device |
| Library | Silence | No vibration | No adjust | No adjust | When |
| | | or vibration | | | wearable |
| | | intensity | | | device is |
| | | minimum | | | used, |
| | | | | | vibration |
| | | | | | is |
| | | | | | set to only |
| | | | | | wearable |
| | | | | | device |

Referring to Table 1, when a surrounding situation of a current position of a smartphone is recognized as a movie theater using information detected using a plurality of sensors, a sound can be set to silence, a vibration notification can be set, screen brightness can be set to a minimum, and a screen can be set to a high contrast inversion mode. In this case, an always on display (AOD) screen mode can be used, and when a smartphone user is using a wearable device, the vibration notification setting can be set and applied only to the wearable device.

For example, when the user of the smartphone checks a notification of the smartphone while watching a movie, screen brightness can be set to a minimum and the smartphone can display a screen in a high contrast mode to enable the user to check the notification.

Further, when a surrounding situation of a current position of the smartphone is recognized as a library, a sound can be set to silence, a vibration may not be set or can be set to weakest vibration intensity, and screen brightness may not be adjusted and a screen may not be also adjusted. In this case, similarly, when the user of the smartphone is using a wearable device, a vibration setting can be set only to the wearable device.

Table 1 shows an example of a notification setting, and a notification setting appropriate to various surrounding situations can be defined.

FIG. 11 is a diagram illustrating a deep neural network structure for the notification providing method proposed in the present specification.

The deep neural network (DNN) shown in FIG. 11 is an example of a learning method used for extracting valid information from information detected through a plurality of sensors as described above, or for extracting valid information to recognize a surrounding situation.

Referring to FIG. 11, the DNN is an artificial neural network (ANN) configured with several hidden layers between an input layer and an output layer. The DNN can model complex non-linear relationships, as in a general artificial neural network. For example, in a deep neural network structure for an object identification model, each object can be represented with a hierarchical configuration of basic elements of an image. In this case, the additional layers can combine characteristics of gradually gathered lower layers. Such a characteristic of the deep neural network can model complex data with only fewer units (nodes), compared with a similarly performed artificial neural network.

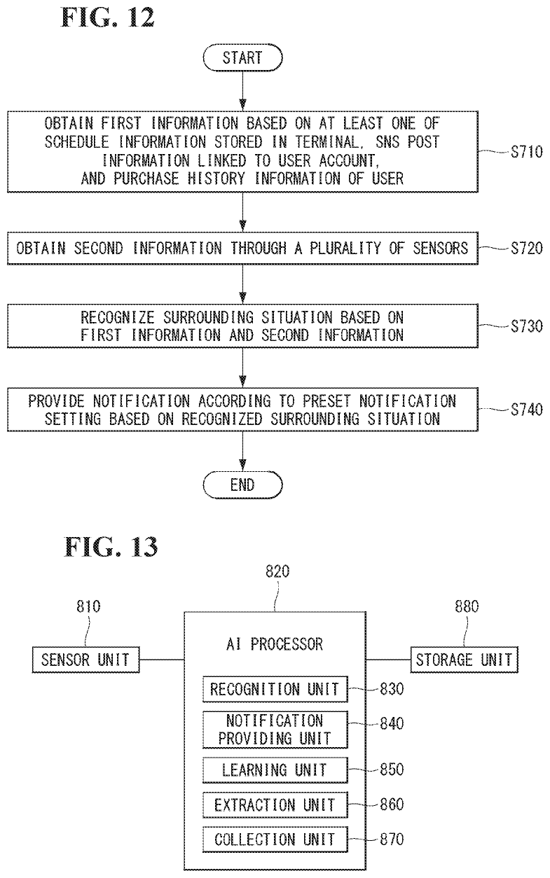

FIG. 12 is a flowchart illustrating an example in which a notification providing method proposed in the present specification is performed.

Referring to FIG. 12, the terminal obtains first information based on at least one of schedule information stored therein, social network service (SNS) post information linked to a user account, and purchase history information of the user (S710).

In this case, the terminal obtains second information through a plurality of sensors (S720).

The terminal recognizes a surrounding situation based on the first information and the second information (S730).

The terminal provides a notification according to a preset notification setting based on the recognized surrounding situation (S740).

The first information can include at least one of information about a specific time and information about a specific position, and the second information can include at least one of position information, sound information, image information, and external signal information.

In this case, the plurality of sensors can be a sensor for detecting at least one of the position information, sound information, image information, and the external signal information.

In this case, the preset notification setting of S740 can include at least one of a sound notification related setting, a screen brightness related setting, a vibration notification related setting, and a screen operation related setting. As shown in Table 1, the preset notification setting can be set in advance according to the surrounding situation, and the smartphone can recognize a surrounding situation detected by the plurality of sensors and provide a preset notification.

Further, the terminal can store the recognized surrounding situation information, and in this case, the preset notification setting can determine the stored recognized surrounding situation information by deep neural network (DNN) learning. In order to more accurately recognize the surrounding situation, the terminal can add a surrounding situation recognized using the surrounding situation detected through the plurality of sensors to a separate inference model in the form of feedback and learn the inference model to improve accuracy.

In this case, the vibration notification related setting can be applied to a wearable device.

Further, the screen operation related setting can be a setting related to an always on display (AOD) or a high contrast screen.

When the second information includes the sound information or the image information, valid information can be extracted through DNN learning of the sound information or the image information, and the recognized surrounding situation can be determined based on the valid information.

FIG. 13 is a block diagram illustrating a terminal configuration in which the notification providing method proposed in the present specification can performed.

Referring to FIG. 13, a terminal for performing a notification providing method can include a sensor unit 810, an AI processor 820, and a storage unit 880.

In this case, the AI processor 820 can include a recognition unit 830, a notification providing unit 840, a learning unit 850, an extraction unit 860, and a collection unit 870.

Hereinafter, an operation performed by each component will be described.

The sensor unit 810 can detect a surrounding situation of a position in which the terminal (smartphone) is currently positioned and be configured with a plurality of sensors.

The AI processor 820 is a processor functionally connected to the sensor unit 810, and can include a notification providing unit 840 that recognizes a surrounding situation through the recognition unit 830 based on a surrounding situation detected by the sensor unit 810 and information (e.g., schedule information stored in the terminal, SNS post information, payment information) collected through the collection unit 870 and that provides a notification according to a preset notification setting based on the recognized surrounding situation.

In this case, a plurality of sensors of the sensor unit 810 can be a sensor for detecting at least one of position information, sound information, image information, and an external signal.

For example, the sensor unit 810 can obtain information including at least one of position information, sound information, image information, and an external signal.

Further, the collection unit 870 can obtain first information based on at least one of schedule information stored in the terminal, SNS post information linked to a user account, and purchase history information of the user, and the first information can include any one of information about a specific time and information about a specific position.

Further, the preset notification setting provided by the notification providing unit 840 can include at least one of a sound notification related setting, a screen brightness related setting, a vibration notification related setting, and a screen operation related setting.

In this case, the preset notification setting can be set for each surrounding situation as shown in Table 1.

The storage unit 880 can store surrounding situation information recognized by the sensor unit 810. In this case, the preset notification setting can be determined by learning DNN of the surrounding situation information stored through the storage unit 880, and thus an optimum notification setting appropriate to each surrounding situation can be provided.

Further, in this case, DNN learning can be performed by the learning unit 850 included in the AI processor 820.

In this case, the screen operation related setting can be a setting related to an always on display (AOD) or a high contrast screen, and the recognized surrounding situation can be determined based on position information detected by a sensor for detecting the position information, a current time, and payment information.

When a plurality of sensors of the sensor unit 810 are a sensor for detecting sound information and a sensor for detecting image information, the AI processor 820 can extract valid information through DNN learning, and the recognized surrounding situation can be determined based on the valid information. In this case, DNN learning can be performed in the learning unit 850, and valid information can be extracted by the extraction unit 860.

There can be an electronic device that includes instructions for performing the above-described notification providing methods of the present invention.

Specifically, the electronic device can include at least one processor, a memory, and at least one program, wherein at least one program can be stored in the memory and be configured to be executed by the at least one processor, and include computer-executable instruction for performing the methods for providing the above-described notifications.

The above-described present disclosure can be implemented with computer-readable code in a computer-readable medium in which program has been recorded. The computer-readable medium can include all kinds of recording devices capable of storing data readable by a computer system. Examples of the computer-readable medium can include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet or short-range technology, storage on a cloud network, etc.). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Advantages and effects of the methods of providing a notification according to one or more embodiments of the present disclosure can include the following, but are not limited thereto.

According to the present disclosure, a smartphone can recognize and grasp surrounding situations using various sensors.

Further, according to the present disclosure, a notification appropriate to a surrounding situation recognized by a smartphone can be provided.

The advantages and effects of the present disclosure are not limited to the above-described advantages and effects and other advantages and effects will be understood by those skilled in the art from the above description.

Regarding the embodiments of the invention being thus described, it will be obvious that the same may be varied in different ways. Such variations are not to be regarded as a departure from the spirit and scope of the embodiments of the invention, and all such modifications as would be obvious to one skilled in the art are intended to be included within the scope of the following claims.

What is claimed is:

1. A method of providing a notification using an intelligent terminal, the method comprising:
obtaining first information based on at least one of schedule information, social network service (SNS) post information, and purchase history information;
obtaining second information through one or more of a plurality of sensors of the intelligent terminal;
recognizing, by at least one processor of the intelligent terminal, a surrounding situation based on the first information and the second information; and
providing a notification according to a preset notification setting based on the recognized surrounding situation,
wherein the second information comprises at least one of position information, sound information, image information, and external signal information.

2. The method of claim 1, wherein the preset notification setting comprises at least one of a sound notification related setting, a screen brightness related setting, a vibration notification related setting, and a screen operation related setting.

3. The method of claim 1, further comprising storing the recognized surrounding situation information in a storage of the intelligent terminal.

4. The method of claim 3, wherein the preset notification setting is determined by deep neural network (DNN) learning of the stored recognized surrounding situation information.

5. The method of claim 2, wherein the vibration notification related setting is applied to a wearable device.

6. The method of claim 2, wherein the screen operation related setting is a setting related to an Always ON Display (AOD) or a high contrast screen.

7. The method of claim 1, further comprising extracting valid information through deep neural network (DNN) learning of the sound information or the image information, when the second information comprises the sound information or the image information,
wherein the recognized surrounding situation is determined based on the valid information.

8. The method of claim 1, wherein the schedule information is schedule information stored in the intelligent terminal, the SNS post information is SNS post information linked to a user of the intelligent terminal, and the purchase history information is purchase history information associated with the user of the intelligent terminal or stored in the intelligent terminal.

9. The method of claim 1, wherein the first information comprises at least one of information about a specific time and information about a specific position.

10. The method of claim 1, wherein the surrounding situation recognizing by the at least one processor of the intelligent terminal includes a place or event in which a user of the intelligent terminal is currently involved.

11. An intelligent terminal for performing a method of providing a notification, the intelligent terminal comprising:
a plurality of sensors configured to obtain information; and
at least one processor functionally connected to the plurality of sensors,
wherein the at least one processor is configured to:
obtain first information based on at least one of schedule information, social network service (SNS) post information, and purchase history information,
obtain second information using one or more of the plurality of sensors,
recognize a surrounding situation based on the first information and the second information, and
provide a notification according to a preset notification setting based on the recognized surrounding situation,
wherein the second information comprises at least one of position information, sound information, image information, and external signal information.

12. The intelligent terminal of claim 11, wherein the preset notification setting comprises at least one of a sound notification related setting, a screen brightness related setting, a vibration notification related setting, and a screen operation related setting.

13. The intelligent terminal of claim 11, further comprising a storage unit configured to store the recognized surrounding situation information.

14. The intelligent terminal of claim 13, wherein the preset notification setting is determined by deep neural network (DNN) learning of the stored recognized surrounding situation information.

15. The intelligent terminal of claim 12, wherein the screen operation related setting is a setting related to an Always ON Display (AOD) or a high contrast screen.

16. The intelligent terminal of claim 11, wherein, when the second information comprises the sound information or the image information, the at least one processor is configured to extract valid information through deep neural network (DNN) learning of the sound information or the image information, and
wherein the recognized surrounding situation is determined based on the valid information.

17. The intelligent terminal of claim 11, wherein the schedule information is schedule information stored in the intelligent terminal, the SNS post information is SNS post information linked to a user of the intelligent terminal, and the purchase history information is purchase history information associated with the user of the intelligent terminal or stored in the intelligent terminal.

18. The intelligent terminal of claim 11, wherein the first information comprises at least one of information about a specific time and information about a specific position.

19. The intelligent terminal of claim 11, wherein the surrounding situation recognizing by the at least one processor of the intelligent terminal includes a place or event in which a user of the intelligent terminal is currently involved.

20. An electronic device, comprising:
at least one processor;
a memory; and
at least one computer program,
wherein the at least one computer program is stored in the memory and is configured to be executed by the at least one processor, and the at least one computer program comprises computer-executable instructions for performing the method of claim 1.
